(19) United States
(12) Patent Application Publication
(10) Pub. No.: US 2009/0108095 A1
(43) Pub. Date: Apr. 30, 2009

(54) Anti-coking fuel injection system

(76) Inventor: Victoriano Ruiz, Roscommon, MI (US)

Correspondence Address: CATERPILLAR/FINNEGAN, HENDERSON, L.L.P., 901 New York Avenue, NW, WASHINGTON, DC, 20001-4413, US

(21) Appl. No.: 11/978,639

(22) Filed: Oct. 30, 2007

(51) Int. Cl. B05B 1/00; B05B 12/00; F02M 61/04

(52) U.S. Cl. 239/102.1; 123/445; 239/533.3; 239/584

(57) ABSTRACT

A fuel injection system is disclosed. The fuel injection system has a nozzle member configured to receive fuel and having at least one injection orifice and a valve disposed with the nozzle member and movable between an open position at which fuel flows through the at least one orifice and a closed position at which fuel flow through the at least one orifice is blocked. The fuel injection system also has an actuator coupled to the valve and configured to move the valve between the open position and the closed position in response to a signal applied thereto and a controller in communication with the actuator, the controller being configured to apply to the actuator an ultrasonic frequency signal such that the valve remains at or between the open position or the closed position and vibrates at the ultrasonic frequency.

### TECHNICAL FIELD

The present disclosure is directed to a fuel injection system and, more particularly, to an anti-coking fuel injection system.

### BACKGROUND

Fuel systems typically employ multiple closed-nozzle fuel injectors to inject high pressure fuel into the combustion chambers of an engine. Each of these fuel injectors includes a nozzle assembly having a cylindrical bore with a nozzle supply passageway and a nozzle outlet. A needle check valve is reciprocatingly disposed within the cylindrical bore and biased toward a closed position where the nozzle outlet is blocked. To inject fuel, the needle check valve is selectively moved to open the nozzle outlet, thereby allowing high pressure fuel to flow from the nozzle supply passageway into the combustion chamber.

Byproducts of combustion tend to accumulate on or near the injector nozzles. As the deposits build up, they can clog the injector nozzle orifices and adversely affect the performance of the fuel injectors. This process, known as injector coking, can lead to reduced fuel economy and increase the amount of pollutants released into the atmosphere through exhaust.

One attempt to reduce fuel injector coking is disclosed in U.S. Pat. No. 6,880,770 issued to Jameson et al. on Apr. 19, 2005 (“the '770 patent”). The '770 patent discloses an injector valve body including an injector needle disposed therein. The injector needle includes a portion made of a magnetostrictive material. During injection, a magnetic field oscillating an at ultrasonic frequency is applied to the magnetostrictive material, which causes the tip of the injector needle to move in and out of a discharge plenum at the ultrasonic frequency. As a result, fuel droplets enter the combustion chamber at an increased velocity. The vibrations may also cause contaminants clogging the injector orifices to breakdown and to be flushed away.

Although the application of ultrasonic energy discussed in the '770 patent may reduce injector coking, it may fall short for a variety of reasons. For example, because the ultrasonic energy displaces the injector needle and allows fuel to enter the combustion chamber, it can only be used during injection. Coking, however, can occur at times other than during injection and under a variety of circumstances. In addition, although the ultrasonic energy may increase the velocity at which fuel droplets enter the combustion chamber, driving the injector needle with only the ultrasonic frequency may not be the best way to control injection.

This disclosure is directed to overcoming or more of the problems set forth above.

### SUMMARY

One aspect of the disclosure is directed to a fuel injection system. The fuel injection system may include a nozzle member configured to receive fuel and having at least one injection orifice, a valve disposed with the nozzle member and movable between an open position at which fuel flows through the at least one orifice and a closed position at which fuel flow through the at least one orifice is blocked, and an actuator coupled to the valve and configured to move the valve between the open position and the closed position in response to a signal applied thereto. The system may also include a controller in communication with the actuator. The controller may be configured to apply to the actuator an ultrasonic frequency signal such that the valve remains at or between the open position or the closed position and vibrates at an ultrasonic frequency.

Another aspect of the disclosure is directed to an anti-coking method for a fuel injection system. The method may include receiving fuel in a nozzle having at least one injection orifice. The method may further include disposing a valve with the nozzle at or between an open position at which fuel flows through the at least one orifice or a closed position at which fuel flow through the at least one orifice is blocked and vibrating the valve at an ultrasonic frequency such that that the valve remains disposed at or between the open position or the closed position during the ultrasonic frequency vibration.

### BRIEF DESCRIPTION OF THE DRAWINGS

FIG. 1 is a schematic and diagrammatic illustration of an exemplary disclosed fuel system;

FIG. 2 is a cross-sectional diagrammatic illustration of an exemplary disclosed fuel injector for the fuel system of FIG. 1; and

FIG. 3 is a schematic representation of an exemplary disclosed fuel injection controller for use with the injector of FIG. 2.

### DETAILED DESCRIPTION

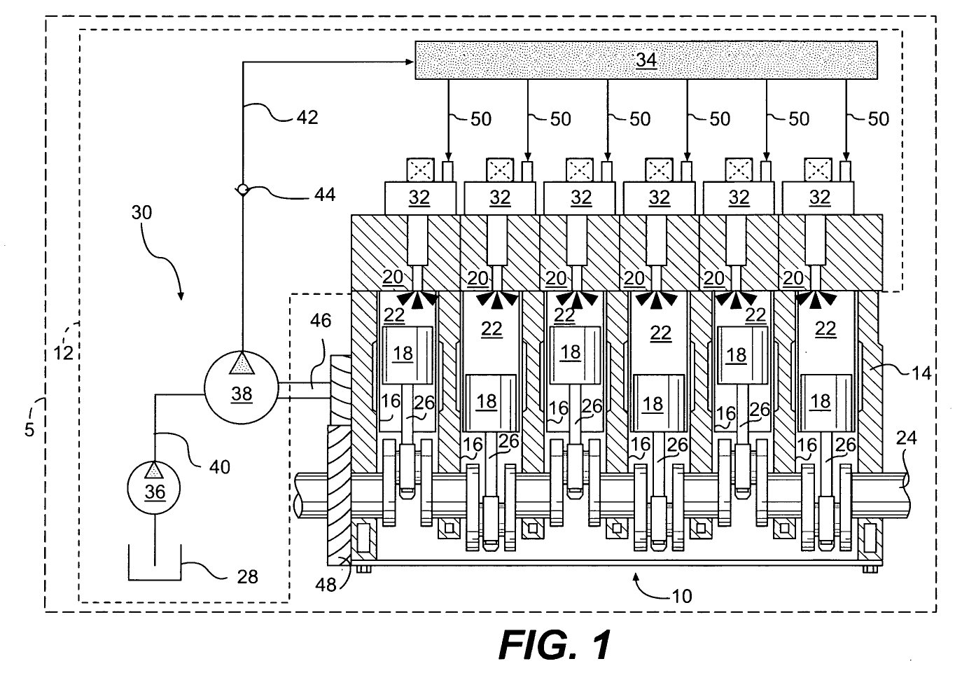

FIG. 1 illustrates an engine 10 and an exemplary embodiment of a fuel system 12 for use with a machine 5. Machine 5 may be any stationary or mobile machine in which operations thereof are powered by a combustion engine, such as, for example, an on- or off-road truck, a passenger vehicle, excavation equipment, a generator set, etc. For the purposes of this disclosure, engine 10 is depicted and described as a four-stroke diesel engine. One skilled in the art will recognize, however, that engine 10 may embody any other type of internal combustion engine such as, for example, a gasoline or a gaseous fuel-powered engine. Engine 10 may include an engine block 14 that defines a plurality of cylinders 16, a piston 18 slidably disposed within each cylinder 16, and a cylinder head 20 associated with each cylinder 16.

Cylinder 16, piston 18, and cylinder head 20 may form a combustion chamber 22. In the illustrated embodiment, engine 10 includes six combustion chambers 22. However, it is contemplated that engine 10 may include a greater or lesser number of combustion chambers 22 and that combustion chambers 22 may be disposed in an “in-line” configuration, a “V” configuration, or any other suitable configuration.

As also shown in FIG. 1, engine 10 may include a crankshaft 24 that is rotatably disposed within engine block 14. A connecting rod 26 may connect each piston 18 to crankshaft 24 so that a sliding motion of piston 18 within each respective cylinder 16 results in a rotation of crankshaft 24. Similarly, a rotation of crankshaft 24 may result in a sliding motion of piston 18.

Fuel system 12 may include components that cooperate to deliver injections of pressurized fuel into each combustion chamber 22. Specifically, fuel system 12 may include a tank 28 configured to hold a supply of fuel, and a fuel pumping arrangement 30 configured to pressurize the fuel and direct the pressurized fuel to a plurality of fuel injectors 32 by way of a common rail 34.

Fuel pumping arrangement 30 may include one or more pumping devices that function to increase the pressure of the fuel and direct one or more pressurized streams of fuel to common rail 34. In one example, fuel pumping arrangement 30 includes a low pressure source 36 and a high pressure source 38 disposed in series and fluidly connected by way of a fuel line 40. Low pressure source 36 may be a transfer pump configured to provide low pressure feed to high pressure source 38. High pressure source 38 may be configured to receive the low pressure feed and to increase the pressure of the fuel to the range of about 30-300 MPa. High pressure source 38 may be connected to common rail 34 by way of a fuel line 42. A check valve 44 may be disposed within fuel line 42 to provide for one-directional flow of fuel from fuel pumping arrangement 30 to common rail 34.

One or both of low pressure and high pressure sources 36, 38 may be operably connected to engine 10 and driven by crankshaft 24. Low and/or high pressure sources 36, 38 may be connected with crankshaft 24 in any manner readily apparent to one skilled in the art where a rotation of crankshaft 24 will result in a corresponding rotation of a pump drive shaft. For example, a pump driveshaft 46 of high pressure source 38 is shown in FIG. 1 as being connected to crankshaft 24 through a gear train 48. It is contemplated, however, that one or both of low and high pressure sources 36, 38 may alternatively be driven electrically, hydraulically, pneumatically, or in any other appropriate manner.

Fuel injectors 32 may be disposed within cylinder heads 20 and connected to common rail 34 by way of a plurality of fuel lines 50. Each fuel injector 32 may be operable to inject an amount of pressurized fuel into an associated combustion chamber 22 at predetermined timings, fuel pressures, and fuel flow rates. The timing of fuel injection into combustion chamber 22 may be synchronized with the motion of piston 18. For example, fuel may be injected as piston 18 nears a top-dead-center position in a compression stroke to allow for compression-ignited-combustion of the injected fuel. Alternatively, fuel may be injected as piston 18 begins the compression stroke heading towards a top-dead-center position for homogenous charge compression ignition operation. Fuel may also be injected as piston 18 is moving from a top-dead-center position towards a bottom-dead-center position during an expansion stroke for a late post injection to create a reducing atmosphere for after-treatment regeneration.

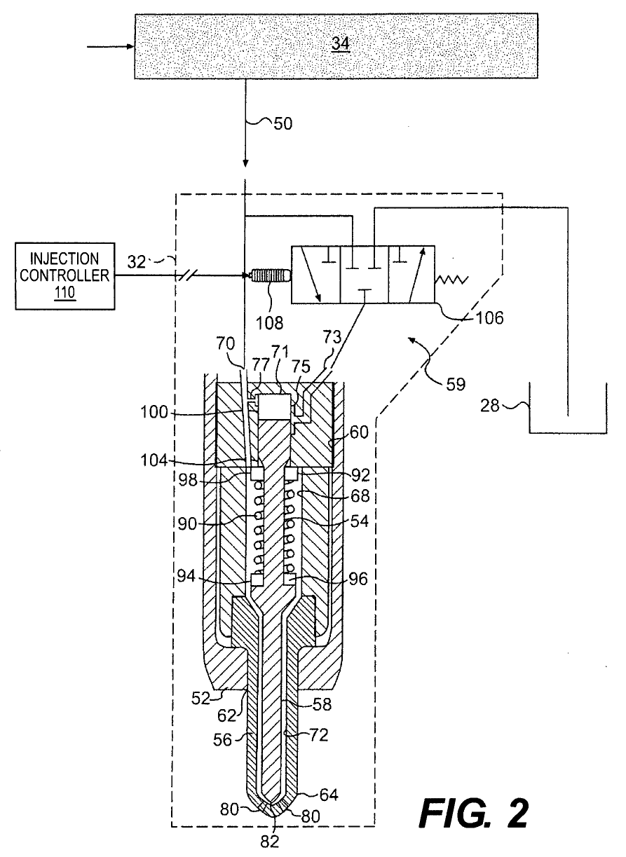

As illustrated in FIG. 2, each fuel injector 32 may embody a closed nozzle unit fuel injector. Specifically, each fuel injector 32 may include an injector body 52 housing a guide 54, a nozzle member 56, a needle valve element 58, and an actuator 59.

Injector body 52 may be a cylindrical member configured for assembly within cylinder head 20. Injector body 52 may have a central bore 60 for receiving guide 54 and nozzle member 56, and an opening 62 through which a tip end 64 of nozzle member 56 may protrude. A sealing member such as, for example, an “O”-ring (not shown) may be disposed between guide 54 and nozzle member 56 to restrict fuel leakage from fuel injector 32.

Guide 54 may also be a cylindrical member having a central bore 68 configured to receive needle valve element 58, and a control chamber 71. Central bore 68 may act as a pressure chamber, holding pressurized fuel that is continuously supplied from a fuel supply passageway 70. During injection, the pressurized fuel from fuel line 50 may be allowed to flow through fuel supply passageway 70 and central bore 68 to nozzle member 56.

Control chamber 71 may be selectively drained of or supplied with pressurized fuel to control motion of needle valve element 58. Specifically, a control passageway 73 may fluidly connect a port 75 of control chamber 71 with actuator 59. Control chamber 71 may also be continuously supplied with pressurized fluid via a supply passageway 77 in communication with fuel supply passageway 70. A diameter of supply passageway 77 may be less than a diameter of control passageway 73 to allow for a pressure drop within control chamber 71 when control passageway 73 is drained of pressurized fuel.

Nozzle member 56 may likewise embody a cylindrical member having a central bore 72 that is configured to receive needle valve element 58. Nozzle member 56 may include one or more orifices 80 to allow the pressurized fuel from central bore 68 into combustion chambers 22 of engine 10.

Needle valve element 58 may be an elongated cylindrical member that is slidingly disposed within housing guide 54 and nozzle member 56. Needle valve element 58 may be axially movable between a first position at which a tip end 82 of needle valve element 58 blocks a flow of fuel through orifices 80 (i.e., a closed position), and a second position at which orifices 80 are open to allow a flow of fuel into combustion chamber 22 (i.e., an open position).

Needle valve element 58 may be normally biased toward the first, orifice-blocking position. In particular, as seen in FIG. 2, each fuel injector 32 may include a spring 90 disposed between a stop 92 of guide 54 and a seating surface 94 of needle valve element 58 to axially bias tip end 82 toward the orifice-blocking position. A first spacer 96 may be disposed between spring 90 and stop 92, and a second spacer 98 may be disposed between spring 90 and seating surface 94 to reduce wear of the components within fuel injector 32.

Needle valve element 58 may have multiple driving hydraulic surfaces. In particular, needle valve element 58 may include a hydraulic surface 100 tending to drive needle valve element 58 toward the first or orifice-blocking position when acted upon by pressurized fuel, and a hydraulic surface 104 that tends to oppose the bias of spring 90 and drive needle valve element 58 in the opposite direction toward the second or orifice-opening position.

Actuator 59 may be disposed opposite tip end 82 of needle valve element 58 to indirectly control the motion of needle valve element 58. In particular, actuator 59 may include a three position proportional valve element 106 disposed within control passageway 73 between control chamber 71 and tank 28. Proportional valve element 106 may be actuated to move between a first position at which fuel is allowed to flow from control chamber 71 to tank 28, a second position at which pressurized fuel from fuel line 50 flows through control passageway 73 into control chamber 71, and a third position at which fuel flow through control passageway 73 is blocked.

Actuator 59 may further include a driving device 108 configured to move proportional valve element 106 between the first, second, and third positions in response to an electric current applied thereto by an injection controller 110. It is contemplated that proportional valve element 106 may alternatively embody a two-position valve element that is movable between only a control chamber draining position and a control chamber filling position, if desired. It is further contemplated that driving device 108 may directly move needle valve element 58 without the use of proportional valve element 106, if desired.

In the first position, needle valve element 58 may be urged away from orifices 80 such that fuel in central bore 68 is released into combustion chamber 22. That is, a pressure difference between hydraulic surfaces 100 and 104 may oppose the bias of spring 90 and urge needle valve element 58 toward the orifice-opening position (i.e., a higher pressure acting on surface 100 than on surface 104). In the second position, needle valve element 58 may be urged toward orifices 80 such that fuel cannot flow from central bore 68 into combustion chamber 22. That is, the pressure difference between hydraulic surfaces 100 and 104 may be reduced, equalized, or reversed to allow spring 90 to urge needle valve element 58 toward the orifice-blocking position. In third position, the forces acting on needle valve element 58 may be such that needle valve element remains stationary. Further, the position of proportional valve element 106 between the first, second, and third positions may determine a flow rate of the fuel through control passageway 73, in addition to the flow direction.

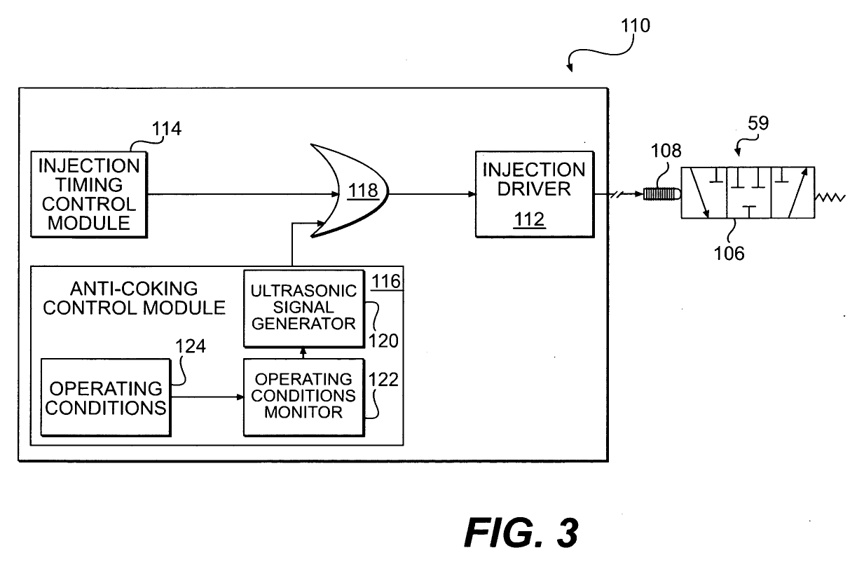

Referring to FIG. 3, injection controller 110 may include any processing means capable of executing and/or or outputting command signals in response to received and/or stored information to affect, among other things, the processes disclosed herein (e.g., an engine control module). Controller 110 may include computer-readable storage, such as read-only memories (ROM), random-access memories (RAM), and/or flash memory; secondary storage device(s), such as a tape-drive and/or magnetic disk drive; microprocessor(s) (CPU), and/or any other components for running an application. The microprocessor(s) may comprise any suitable combination of commercially-available or specially-constructed microprocessors. Controller 110 may include instructions and/or data stored as hardware, software, and/or firmware within the memory, secondary storage device(s), and/or microprocessor(s). Alternatively or additionally, controller 110 may include and/or be associated with various other suitably arranged hardware and/or software components. For example, controller 110 may further include power supply circuitry, signal conditioning and/or generating circuitry, solenoid driver circuitry, amplifier circuitry, timing circuitry, filtering circuitry, switches, and/or other types of circuitry, if desired.

Controller 110 may include, among other things, an injection driver module 112 operatively connected to an injection timing control module 114 and an anti-coking control module 116. Injection timing control module 114 and anti-coking control module 116 may be connected to injection driver module 112 via coupling means 118.

Injection driver module 112 may comprise any means known in the art to produce an injector driving signal to drive actuator 59 (i.e., proportional valve element 106) and thereby move needle valve element 58 between the orifice-opening and blocking positions in response to an input signal. As shown in FIG. 3, injection driver module 112 may be configured to receive an input signal from injection timing control module 114 (i.e., an injection timing control signal). Injection driver module 112 may include, for example, a Darlington pair circuit or another suitable driving circuit known in the art for amplifying an input signal to a level sufficient to drive actuator 59 between its respective positions and thereby control fuel flow through orifices 80 (i.e., an injector driving signal). In another example, injection driver module 112 may include a signal processor configured to receive as input a digital encoded signal and output a corresponding analog signal to drive actuator 59.

Injection timing control module 114 may include any means known in the art for generating an injection timing control signal. Injection timing control module 114 may control the nature and extent of fuel flow from nozzle member 56, through orifices 80, and into combustion chamber 22. For example, injection timing control module 114 may monitor parameters such as engine speed, engine rotational position (e.g., the angular position of piston 18), desired engine torque (e.g., accelerator depression), engine load, and/or other operational parameters determined or provided by associated systems and generate an injection timing control signal based thereon. The signal may embody, for example, a pulse width modulated (PWM) signal in which a pulse width or duty cycle thereof controls actuator 59, and thus, the movement of needle valve element 58 between the orifice-blocking and opening positions. It is to be appreciated, however, that injection timing control module 114 may provide to injection driver module 112 a signal having any characteristic(s) suitable to control actuator 59. For instance, the signal may embody a frequency-modulated signal, an amplitude-modulated signal, an encoded digital signal, any other suitable signal.

Anti-coking control module 116 may be configured to provide to injection driver module 112 an ultrasonic frequency signal to prevent, reduce, and/or break down contaminants that tend to form, as a result of combustion, on or near tip end 64 of nozzle member 56 and clog orifices 80 or otherwise adversely affect the performance of fuel injectors 32. Anti-coking control module 116 may include an ultrasonic frequency signal generator 120 and a system operating conditions monitoring module 122.

Ultrasonic frequency signal generator 120 may embody any means for generating a signal having at least one ultrasonic frequency component. That is, the signal may include a single ultrasonic frequency component, multiple ultrasonic frequency components, one or more ultrasonic frequency bands, and/or suitable combinations thereof. Ultrasonic frequency signal generator 120 may comprise, for example, an electronic oscillator circuit configured to generate a repetitive output signal having at least one ultrasonic frequency component in response to an input command signal. The output signal may include a sine wave, a sawtooth wave, a step (pulse) wave, a square wave, a triangular wave, or another waveform known in the art. Alternatively, ultrasonic frequency signal generator 120 may be configured to generate an encoded digital signal defining a waveform signal having the at least one ultrasonic frequency component.

The ultrasonic frequency signal may be received as input by injection driver module 112. Injection driver module 112 may, in turn, apply a corresponding ultrasonic frequency driving signal to actuator 59. The ultrasonic frequency driving signal may be outside the frequency response range of actuator 59. That is, the at least one ultrasonic frequency may be too high to move proportional valve element 106 between the first and second positions. In particular, the duration for which the ultrasonic frequency signal commands actuator 59 may be insufficient to allow proportional valve element 106 to move between the first and second positions. Put another way, actuator 59 may be too “slow” to respond completely to the ultrasonic frequency driving signal. As a result, proportional valve element 106 may remain in one of the first through third positions, in accordance with the injection timing control signal provided by injection timing control module 114, and vibrate at the at least one ultrasonic frequency in accordance with the ultrasonic frequency signal provided by ultrasonic frequency signal generator 120.

This ultrasonic frequency vibration may, in turn, manifest itself as ultrasonic frequency pressure oscillations applied to needle valve element 58. In particular, hydraulic surfaces 100 and 104 may undergo ultrasonic pressure oscillations. The oscillations may cause needle valve element 58 to vibrate at the at least one ultrasonic frequency present in the ultrasonic frequency driving signal while remaining in position (i.e., in the position commanded by the injection timing control signal). That is, needle valve element 58 may remain in either the orifice-opening position (first position), the orifice-blocking position (second position), or an intermediate position, while vibrating at the at least one ultrasonic frequency. The ultrasonic frequency signal may be tailored such that the vibrations are insufficient to move needle valve element 58 between the first and third positions. That is, the ultrasonic frequency signal may not appreciably displace needle valve element 58 with respect to blocking or passing fuel flow. For instance, if needle valve element 58 is in the orifice-blocking position, the applied ultrasonic frequency signal may cause needle valve element 58 to vibrate at the at least one ultrasonic frequency, yet remain in the orifice-blocking position (i.e., prevent fuel from passing into combustion chamber 22). Likewise, if needle valve element 58 is in the orifice-opening position, the ultrasonic frequency signal may cause needle valve element 58 to vibrate at the at least one ultrasonic frequency, yet remain in the orifice-opening position (i.e., allow fuel to pass into combustion chamber 22). In addition, the vibrational energy of needle valve element 58 may be transferred to nozzle member 56, especially when needle valve element 58 is in the orifice-blocking position. The vibrational energy may also be transferred to the fuel during injection.

The ultrasonic frequency signal may be configured such that the vibrations induced thereby prevent, reduce, and/or break down contaminants that tend to form, on or near needle valve element 58 and/or tip end 64 of nozzle member 56, and clog orifices 80 or otherwise adversely affect the performance of fuel injectors 32 (i.e., coking). Specifically, the at least one ultrasonic frequency, and/or the waveform shape of the signal, may be chosen to prevent or reduce injector coking. For instance, the ultrasonic frequency signal may be tailored based on the type of fuel used (e.g., diesel, leaded gasoline, unleaded gasoline), operating engine speeds, operating engine temperatures, the extent and nature of machine usage (e.g., used in hot or cold weather; daily, hourly, weekly, intermittently, etc.), the type of material(s) used to make fuel injector 32, the response characteristics of actuator 59, etc. As such, any suitable ultrasonic frequency or frequencies may be used, depending on the intended application. In one aspect, the frequency or frequencies may range from 15 to 400 kHz.

Operating conditions monitoring module 122 may include any means to switch on and off ultrasonic frequency signal generator 120 based on received operating conditions 124. Operating conditions 124 may include signals provided by an ECM indicative of values of certain operational parameters of the machine 5, engine 10, fuel system 12, and/or other systems or subsystems associated therewith. Operating conditions 124 may include, for example, a coolant temperature, an engine speed, an engine temperature, a travel speed, a rate of fuel flow, an exhaust contamination level, an exhaust temperature level, an amount of accelerator depression, or any other operational parameters that may be measured or tracked by an ECM.

Specifically, operating conditions monitoring module 122 may be configured to receive, track, or otherwise monitor operating conditions 124, and to compare the parameter values thereof to thresholds and/or ranges stored in memory. For example, operating conditions monitoring module 122 may access stored thresholds or ranges for coolant temperature (e.g., less than 165° F.), an engine speed (e.g., between 500 RPM and 1200 RPM), an engine temperature (e.g., 220° F.), exhaust contamination level (e.g., 150 ppm), an engine on/off state, etc. If operating conditions monitoring module 122 determines, upon comparison, that at least one of the monitored operating conditions 124 falls above or below the stored thresholds, within or outside the stored ranges, etc., a command signal may be sent to ultrasonic frequency signal generator 120 to generate the ultrasonic frequency signal.

The stored thresholds and/or ranges may be chosen based on the type of fuel to be used, the nature and extent of machine usage, the material(s) used to make fuel injector 32 or other components of fuel system 12, etc., the particular application, and/or other knowledge of injector coking. For example, it may be known that contaminants tend to form during the period immediately after engine shutdown (“engine soak”). As such, operating conditions monitoring module 122 may be configured to trigger ultrasonic frequency signal generator 120 for a period of time (e.g., 15 minutes) after an “engine off” signal is received. In this manner, needle valve element 58 may remain in the orifice-blocking position (i.e., preventing fuel flow) while vibrating at the at least one ultrasonic frequency. The vibrations may tend to reduce the formation of contaminants on or near needle valve element 58 and/or nozzle member 56 during this period. In another example, operating conditions monitoring module 122 may be configured to trigger ultrasonic frequency signal generator 120 while engine 10 is warming up and/or cooling down, and the coolant temperature is between 100° F. and 150° F. It is to be appreciated, however, that operating conditions monitoring module 122 may be configured to trigger ultrasonic frequency signal generator 120 under any conditions under which injector coking is known to occur.

Coupling means 118 may comprise any component able to receive and to apply the injection timing control signal output from injection timing control module 114 and/or the ultrasonic frequency signal output from ultrasonic frequency signal generator 120 to injection driver module 112. In one embodiment, coupling means 118 may be an OR gate. In this manner, anti-coking control module 116 and injection timing control module 114 may be used to drive fuel injector 32 alone or simultaneously. That is, the ultrasonic frequency signal may be “superimposed” on the extant injector timing control signal to vibrate needle valve element 58 ultrasonically while needle valve element 58 is being driven between the orifice-blocking position and the orifice-opening position during injection. Coupling means 118 may also allow the injector timing control signal to alone drive fuel injector 32 while anti-coking control module 116 is inoperative. Similarly, coupling means 118 may allow the ultrasonic frequency signal to alone drive (i.e., vibrate) needle valve element 58 while injector timing control module 114 is not outputting an injector timing control signal, such as when engine 10 is off.

### INDUSTRIAL APPLICABILITY

The disclosed injection control system may be used in connection with any internal combustion engine. The disclosed system may be particularly useful in combustion engines prone to injector coking. Because the disclosed system allows the injector valve to be vibrated at an ultrasonic frequency without displacing the valve from its commanded position, anti-coking precautions may be taken irrespective of whether the engine is operative or inoperative. In addition, the disclosed injection control system may allow anti-coking measures to be taken when certain conditions conducive to injector coking arise. Operation of the disclosed system will now be described.

Upon the starting of engine 10, injection timing control module 114 may generate an injection timing control signal used by injection driver module 112 to drive fuel injector 32, as discussed above. During engine operation, operating conditions monitoring module 122 may monitor the operating conditions 124 of engine 10, of fuel system 12, and/or of any other systems associated with machine 5.

In one example, operating conditions monitoring module 122 may detect that the coolant temperature has dropped below a stored threshold known to be conducive to injector coking. In response, operating conditions monitoring module 122 may trigger operation of ultrasonic frequency signal generator 120. An ultrasonic frequency signal may be generated and superimposed on the extant injection timing control signal by coupling means 118. Injection driver module 112 may thus produce an injector driving signal to drive actuator 59 using the superimposed signal. As a result, needle valve element 58 may move between the orifice-blocking and orifice-opening positions, in accordance with the injection timing driving signal, while vibrating ultrasonically in accordance with the ultrasonic frequency signal.

During subsequent operation, the monitored coolant temperature may rise above the stored threshold value. In response, operating conditions monitoring module 122 may cause ultrasonic frequency signal generator 120 to cease generating the ultrasonic frequency signal. As such, subsequent control of injection may be based only on the injection timing control signal. Specifically, the injection timing control signal provided injection timing control module 114 to injection driver module 112 via coupling means 118 may be used by injection driver module 112 to produce a corresponding injection driver signal to thereby drive actuator 59 and control injection.

Subsequently, engine 10 may be powered down. Operating conditions monitoring module 122 may receive an indication that engine 10 has been shut off. In response, operating conditions monitoring module 122 may trigger operation of ultrasonic frequency signal generator 120 for a period of time (e.g., 15 minutes) stored in memory after receiving the indication. Injection driver module 112 may receive the ultrasonic frequency signal and drive actuator 59 in response to the signal. As a result, needle valve element 58 may remain in the orifice-blocking position, such that fuel flow through orifices 80 and into combustion chamber 22 is blocked, and vibrate at the at least one ultrasonic frequency.

By employing the disclosed fuel injection control system, fuel injector coking may be reduced. In particular, the disclosed fuel system may provide for ultrasonic frequency vibration of the injector valves during injection in response to monitored operating conditions. In addition, the disclosed fuel injection control system provides for ultrasonic frequency vibration of the injector valves for a period of time after the engine has been shut down (i.e., during engine soak). In this manner, anti-coking measures may be taken during or after engine operation at times when injector coking is prone to occur. Still further, because the ultrasonic frequency signal may have a frequency outside the response range of the injector actuators, the ultrasonic frequency signal may not independently displace the injector valves from either the fuel closed or passing positions. As such, ultrasonic frequency vibrational energy may be provided to the injectors while engine is off, without allowing fuel to flow into the combustion chambers.

It will be apparent to those skilled in the art that various modifications and variations can be made to the fuel system of the present disclosure without departing from the scope of the disclosure. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A fuel injection system, comprising:
a nozzle member configured to receive fuel and having at least one injection orifice;
a valve disposed with the nozzle member and movable between an open position at which fuel flows through the at least one orifice and a closed position at which fuel flow through the at least one orifice is blocked;
an actuator coupled to the valve and configured to move the valve between the open position and the closed position in response to a signal applied thereto; and
a controller in communication with the actuator, the controller being configured to apply to the actuator an ultrasonic frequency signal such that the valve remains at or between the open position or the closed position and vibrates at an ultrasonic frequency.

2. The system of claim 1, wherein the controller is further configured to receive an indication of an operating condition of an associated machine, wherein the ultrasonic frequency signal is applied based on the indication.

3. The system of claim 2, wherein the indication includes a parameter value of the operating condition, and the controller is further configured to apply the ultrasonic frequency signal if the parameter value falls outside a range.

4. The system of claim 2, wherein the operating condition includes at least one of a coolant temperature, a travel speed, an engine speed, and an engine on/off state.

5. The system of claim 1, associated with an engine arranged to receive the fuel flow through the at lease one orifice, wherein the controller is further configured to:
receive an indication that the engine has been shut off; and
apply the ultrasonic frequency signal for a period of time after receiving the indication and in response thereto, wherein the valve remains at the closed position and vibrates at the ultrasonic frequency.

6. The system of claim 1, wherein the controller is further configured to:
apply to the actuator an injector driving signal operable to move the valve between the open position and the closed position; and
superimpose the ultrasonic frequency signal on the injector driving signal such that the valve vibrates at the ultrasonic frequency while moving between the open position and the closed position.

7. The system of claim 1, wherein the frequency of the ultrasonic frequency signal is outside a frequency response range of the actuator.

8. The system of claim 1, wherein the ultrasonic frequency vibration is insufficient to move the valve between the open position and the closed position.

9. An anti-coking method for a fuel injection system, comprising:
receiving fuel in a nozzle having at least one injection orifice;
disposing a valve with the nozzle at or between an open position at which fuel flows through the at least one orifice or a closed position at which fuel flow through the at least one orifice is blocked; and
vibrating the valve at an ultrasonic frequency such that the valve remains disposed at or between the open position or the closed position during the ultrasonic frequency vibration.

10. The method of claim 9, further including receiving an indication of an operating condition of a machine associated with the fuel injection system, wherein the ultrasonic frequency vibration is initiated based on the indication.

11. The method of claim 10, wherein the indication includes a parameter value of the operating condition, and the ultrasonic frequency vibration is initiated if the parameter value falls outside a range.

12. The method of claim 10, wherein the operating condition includes at least one of a coolant temperature, a travel speed, an engine speed, an engine on state, and an engine off state.

13. The method of claim 9, further including:
receiving an indication that an associated engine has been shut off;
carrying out the ultrasonic frequency vibration for a period of time after receiving the indication and in response thereto, and
maintaining the valve in the flow-blocking position during the ultrasonic frequency vibration.

14. The method of claim 9, further including:
driving the valve between the open position and the closed position during injection; and
superimposing the ultrasonic frequency vibration on the driving such that the valve vibrates at the ultrasonic frequency while moving between the open position and the closed position.

15. The method of claim 9, wherein the ultrasonic frequency vibration is insufficient to move the valve between the open position and the closed position.

16. A machine, comprising:
a combustion engine configured to power operations of the machine; and
a fuel injection system configured to supply fuel to the engine, the fuel injection system comprising:
a nozzle member configured to receive fuel and having at least one injection orifice;
a valve disposed with the nozzle member and movable between an open position at which fuel flows through the at least one orifice and a closed position at which fuel flow through the at least one orifice is blocked;
an actuator coupled to the valve and configured to move the valve between the open position and the closed position in response to a signal applied thereto; and
a controller in communication with the actuator, the controller being configured to apply to the actuator an ultrasonic frequency signal such that the valve remains at or between the open position or the closed position and vibrates at an ultrasonic frequency.

17. The machine of claim 16, wherein the controller is further configured to receive an indication of an operating condition of an associated machine, wherein the ultrasonic frequency signal is applied based on the indication.

18. The machine of claim 17, wherein the operating condition includes at least one of a coolant temperature, a travel speed, an engine speed, an engine on state, and an engine off state.

19. The machine of claim 16, wherein the controller is further configured to:
receive an indication that the engine has been shut off; and
apply the ultrasonic frequency signal for a period of time after receiving the indication and in response thereto, wherein the valve remains at the closed position and vibrates at the ultrasonic frequency.

20. The machine of claim 16, wherein the controller is further configured to:
apply to the actuator an injector driving signal operable to move the valve between the open position and the closed position; and
superimpose the ultrasonic frequency signal on the injector driving signal such that the valve vibrates at the ultrasonic frequency while moving between the open position and the closed position.
